(19) United States
(12) Patent Application Publication
(10) Pub. No.: US 2005/0249421 A1
(43) Pub. Date: Nov. 10, 2005

(54) Electrical apparatus with image capture unit

(75) Inventors: Ching Sung Yeh, Taipei (TW); Yu-Chi Lee, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/124,102

(22) Filed: May 9, 2005

(30) Foreign Application Priority Data
May 10, 2004 (TW) 093113103

(51) Int. Cl. G06K 9/36

(52) U.S. Cl. 382/232

(57) ABSTRACT

An electrical apparatus with an image capture unit includes a casing, an image capture unit and a connection unit. The casing has a container and a first fasten portion set in the container. The image capture unit has a second fasten portion. When the second fasten portion connects with the first fasten portion, the image capture unit is fastened in the container. The connection unit connects the image capture unit and the casing. At least one portion of the connection unit is made of a flexible material. When the first fasten portion is separated from the second fasten portion, the image capture unit and at least one portion of the connection unit are pull out and exposed out of the casing. Then, when applying a force to the connection unit, the shape of the connection unit is modified.

### BACKGROUND OF THE INVENTION

1. Field of Invention

The invention relates to an electrical apparatus and, in particular, to an electrical apparatus comprising an image capture unit having adjustable shooting angles and direction.

2. Related Art

Due to improvements in technology, notebook computers are lightweight and compact, which are the main consumer selling points in the computer industry. In addition, owing to the wide spreading of the internet and the enhancement of network bandwidth, an image captured by an image capture unit can be displayed as real time on a computer screen with the combination of the computer and image capture unit. In conjunction with the appropriate software, a remote meeting or remote educational session can be held.

Conventionally, there are two ways to connect an image capture unit with a notebook computer, namely the external type and the built-in type, as described respectively as follows.

An external image capture unit needs to be connected to a notebook computer by a user. Therefore, the user has to carry an external image capture unit, which is inconvenient and will increase the load for the carrier.

On the other hand, as shown in FIG. 1, a built-in image capture unit 11 is set aside as display screen 12 of a notebook computer 1. The user can pull out the image capture unit 11 from the notebook computer 1 and the captured image can be displayed on the display screen 12 of the notebook computer 1 with the appropriate software.

Since the image capture unit 11 is built into the notebook computer 1, it can only be moved within limited directions. Therefore, only the image from a fixed direction, for example, the person or object in front of the notebook computer 1, can be captured in the image capture unit 11, and if the person or object to be taken keeps changing position, or is in at an angle that the image capture unit 11 cannot capture, then one has to move the notebook computer 1 to the proper position and adjust the angle to keep the person or object in the effective field of the image capture unit 11. This will cause a lot of inconvenience when using the image capture unit 11.

It is therefore an objective of the invention to provide a user-friendly electronic apparatus for solving the aforementioned disadvantages.

### SUMMARY OF THE INVENTION

In view of the foregoing, the present invention will provide an electrical apparatus comprising an image capture unit with an adjustable shooting angle and direction.

To achieve the above, an electrical apparatus of the invention comprises a casing, an image capture unit and a connection unit. The casing has a container and a first fasten portion set in the container. The image capture unit has a second fasten portion. When the second fasten portion connects with the first fasten portion, the image capture unit is fastened in the container. The connection unit connects the image capture unit and the casing. At least one portion of the connection unit is made of a flexible material. When applying a force to the connection unit, the shape of the connection unit is changed. When the first fasten portion is separated from the second fasten portion, the image capture unit and at least one portion of the connection unit are exposed out of the casing.

As mentioned above, the electrical apparatus of the invention has a flexible connection unit, so that the shooting angle and direction can be adjusted by extending or rotating the image capture unit and is not restrained by the position of the electrical apparatus. Since relatively positions between the image capture unit and electrical apparatus are adjustable, it is unnecessary to change the direction and angle of the electrical apparatus in order to catch a person or object, which is out of the field of the image capture unit. Accordingly, it is convenient to use the image capture unit.

### BRIEF DESCRIPTION OF THE DRAWINGS

The invention will become more fully understood from the detailed description given herein below illustration only, and thus is not limitative of the present invention, and wherein:

FIG. 1 is a diagram of the conventional image capture unit built in a notebook computer;

FIG. 2a is a diagram of an image capture unit fixed to a container according to a preferred embodiment of the invention;

FIG. 2b is a diagram of an image capture unit and connection unit exposed from a casing according to a preferred embodiment of the invention;

FIG. 3 is a partial diagram of an image capture unit according to a preferred embodiment of the invention;

FIG. 4 is a diagram of an image capture unit and a connection unit according to a preferred embodiment of the invention;

FIG. 5a is an assembly diagram of an electrical apparatus and an image capture unit according to a preferred embodiment of the present invention;

FIG. 5b is a diagram of an electrical apparatus and an image capture unit in use according to a preferred embodiment of the invention;

FIG. 6a is another assembly diagram of an electrical apparatus and an image capture unit according to a preferred embodiment of the invention; and

FIG. 6b is another diagram of an electrical apparatus and an image capture unit in use according to a preferred embodiment of the invention.

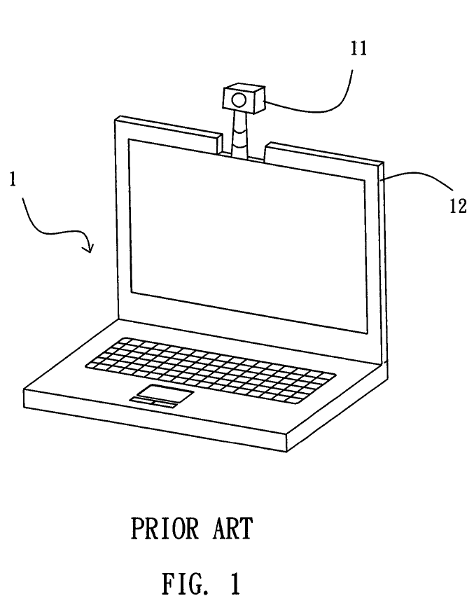

### DETAILED DESCRIPTION OF THE INVENTION

The present invention will be apparent from the following detailed description, which proceeds with reference to the accompanying drawings, and the same references relate to the same elements.

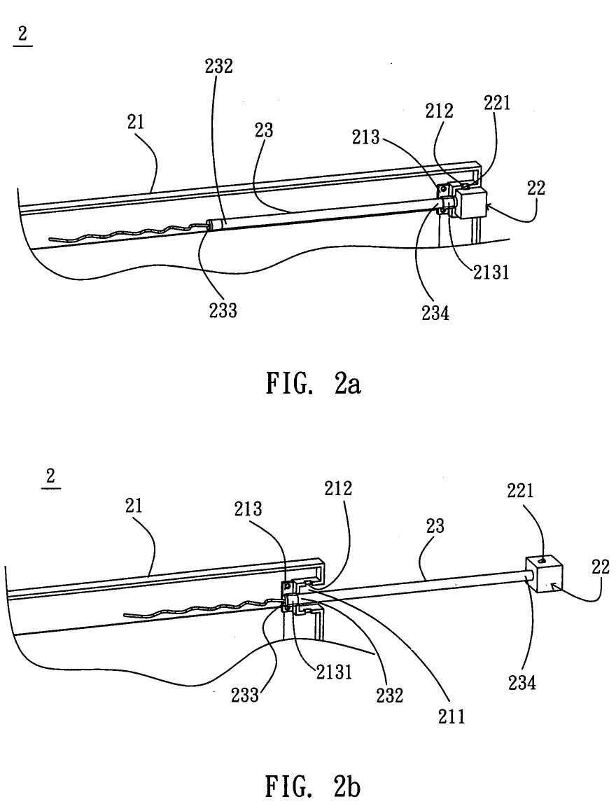

By viewing FIG. 2a and FIG. 2b, an electrical apparatus 2 according to a preferred embodiment of the invention comprises a casing 21, an image capture unit 22 and a connection unit 23.

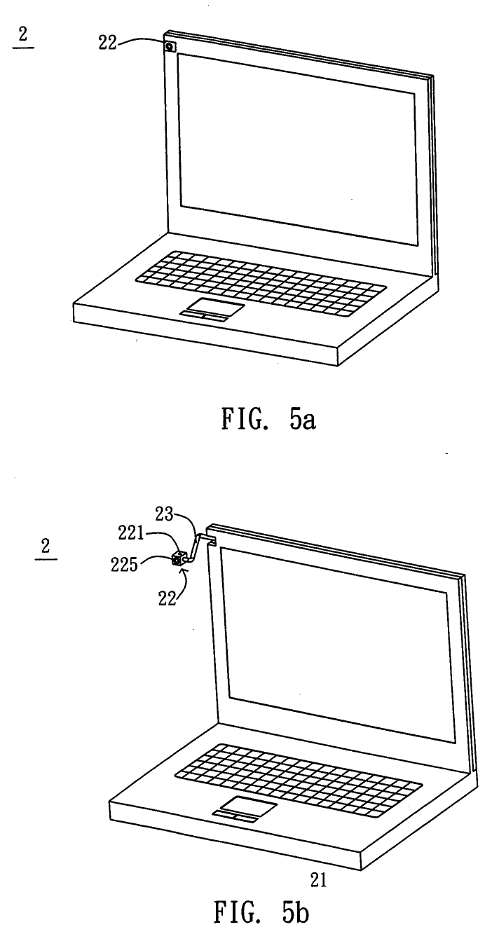

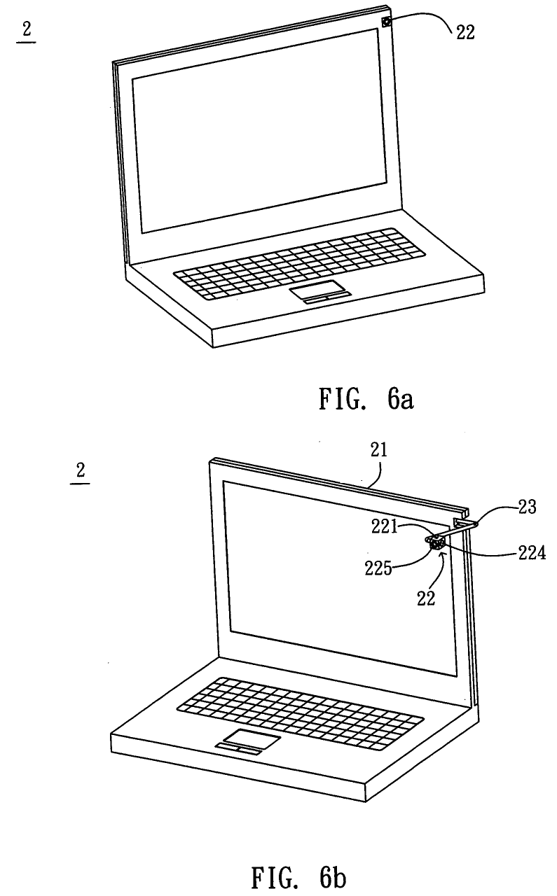

The casing 21 has a container 211 and a first fasten portion 212. The container 211 can be located on either side of the casing 21 on demand. In this embodiment, the container 211 is, as shown in FIG. 5a, located on the left side of the electrical apparatus 2 or, as shown in FIG. 6a, located on the right side thereof. The first fasten portion 212 is set in the container 211. The first fasten portion 212 is a concave portion in this embodiment. In addition, the casing 21 further comprises a through hole 2131, which, in this embodiment, is the inner margin of a hooking ring 213 screwed on the casing 21.

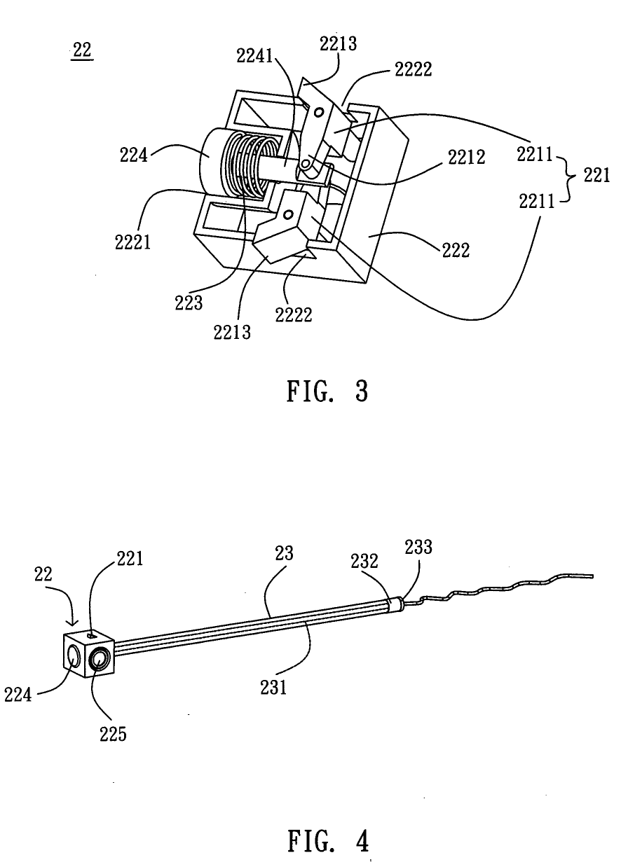

As shown in FIG. 3, the image capture unit 22 comprises a second fasten portion 221 which has at least one hook 2211. The second fasten portion 221 has two hooks in this embodiment. Further, the image capture unit 22 further comprises a shell casing 222, an elastic unit 223 and a button 224. The shell casing 222 comprises a first opening 2221 and at least a second opening 2222. The button 224 is located at the first opening 2221, and has a transmission arm 2241 that penetrates through the elastic unit 223 and connects to a first portion 2212 of the hook 2211, so that the hook 2211 is moved along with the button 224. A second portion 2213 of the hook 2211 is located at the second opening 2222.

When a user presses the button 224, the elastic unit 223 is compressed and the transmission arm 2241 pushes the first portion 2212 of the hook 2211, causing the second portion 2213 of the hook 2211 being hidden in the shell casing 222. In addition, as shown in FIG. 4, the image capture unit 22 further comprises a charge couple device (CCD) 225 for shooting pictures.

Further, as shown in FIG. 2a, when the second fasten portion 221 connects with the first fasten portion 212, the image capture unit 22 is fasten in the container 211. When the second fasten portion 221 is separated from the first fasten portion 212, as shown in FIG. 2b, the image capture unit 22 and one portion of the connection unit 23 are exposed from the casing.

As also shown in FIG. 2a, the connection unit 23, which electrically connects the image capture unit 22 and the casing 21, is made of a flexible material. When applying a force to the connection unit 23, as shown in FIG. 5b, the shape thereof is changed. Moreover, the connection unit 23 further possesses rigidity. When the applied force is stopped, the shape of the connection unit 23 is maintained at the moment the force stops it.

In this embodiment, as shown in FIG. 4 and FIG. 2b, the connection unit 23 comprises a supporting unit 231 so as to enhance the rigidity thereof. The supporting unit 231, for example, is a copper wire, and is located within the connection unit 23.

Further, the second end 234 of the connection unit 23 connects to the image capture unit 22. A stopping unit 233 is disposed on the first end 232 of the connection unit 23, and at least one portion of the connection unit 23 penetrates through the through hole 2131. In this embodiment, the stopping unit 233 has an annular shape and covers the first end 232 of the connection unit 23. As shown in FIG. 2b, the outer diameter of the stopping unit 233 is longer than that of the through hole 2131, so that the stopping unit cannot go through all over the through hole 2131 and only a limited portion of the connection unit 23 are exposed from the casing.

To make the invention more comprehensive, an electrical apparatus according to an embodiment of the invention will be described hereinafter.

When the image capture unit 22 is not in use, the electrical apparatus 2 remains its original state as shown in FIG. 5a and FIG. 6a.

When the image capture unit 22 is in use, as shown in FIG. 5b and FIG. 6b, the user can pull out the image capture unit 22 and a portion of connection unit 23 from the casing 21 by pressing the button 224.

In addition, when adjusting the image capture unit to a specific angle and direction, the user can change the shape of the connection unit 23 by applying a force thereto, and adjust the image capture unit 22 to the desired angle and the direction. When the applied force is stopped, the shape of the connection unit 23 is maintained until the moment the force stops it. The connection unit 22 can hold and maintain the image capture unit 22 in the fixed angle and direction due to the rigidity thereof.

In summary, the electrical apparatus of the invention has a flexible connection unit, so that extending or rotating of the image can adjust the shooting angle and the direction of the capture unit. Thus, the problem that the image capture unit is restrained by the position of the electrical apparatus can be avoided. Since the relative positions between the image capture unit and electrical apparatus are adjustable, it is convenient to use the image capture unit.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An electrical apparatus, comprising:
a casing having a container and a first fasten portion set in the container;
an image capture unit having a second fasten portion, wherein when the second fasten portion connects with the first fasten portion, the image capture unit is fastened in the container; and
a connection unit connecting the image capture unit and the casing, at least one portion of the connection unit being made of a flexible material, wherein when the first fasten portion is separated from the second fasten portion, the image capture unit and at least one portion of the connection unit are exposed out of the casing, and when applying a force to the connection unit, a shape of the connection unit is changed.

2. The electrical apparatus according to claim 1, wherein the connection unit further possesses rigidity, and when the force is stopped applying to the connection unit, the shape of the connection unit is maintained as at the moment the force is stopped.

3. The electrical apparatus according to claim 2, wherein the connection unit further comprises a supporting unit so as to enhance the rigidity of the connection unit.

4. The electrical apparatus according to claim 3, wherein the supporting unit is located in the connection unit.

5. The electrical apparatus according to claim 3, wherein the supporting unit is a copper wire.

6. The electrical apparatus according to claim 1, wherein the casing further comprises a through hole, the connection unit further comprises a first end and a second end, the second end connects to the image capture unit, a stopping unit is disposed at the first end, and at least one portion of the connection unit passes through the through hole.

7. The electrical apparatus according to claim 6, wherein the stopping unit has a annular shape and covers the first end of the connection unit, and the outer diameter of at least one portion of the stopping unit is longer than the diameter of the through hole.

8. The electrical apparatus according to claim 6, wherein the through hole is an inner margin of a hooking ring.

9. The electrical apparatus according to claim 1, wherein the first fasten portion is a concave portion, and the second fasten portion has at least one hook.

10. The electrical apparatus according to claim 9, wherein the image capture unit further comprises a shell casing having a first opening and at least a second opening, an elastic unit, and a button located at the first opening and having a transmission arm that the transmission arm goes through the elastic unit and connects to a first portion of the hook for moving the hook along with the button and a second portion of the hook is located at the second opening.

11. The electrical apparatus according to claim 10, wherein when the button pressed, the elastic unit is compressed and the transmission arm pushes the first portion of the hook for hiding the second portion of the hook to the shell casing.

12. The electrical apparatus according to clam. 1, wherein the image capture unit further comprises a charge couple device (CCD).

13. The electrical apparatus according to claim 1, wherein the container is disposed in any one side of the casing.
